(19) United States
(12) Patent Application Publication
(10) Pub. No.: US 2016/0354854 A1
(43) Pub. Date: Dec. 8, 2016

(54) Systems and Methods for Weld Distortion Reduction via a Dynamically Controlled Heat Source

(71) Applicant: Caterpillar Inc., Peoria, IL (US)

(72) Inventors: Huijun Wang, Peoria, IL (US); Michael Noble, Peoria, IL (US); Nien Lee, Peoria, IL (US); Howard Ludewig, Groveland, IL (US); Donald Stickel, Chillicothe, IL (US)

(73) Assignee: Caterpillar Inc., Peoria, IL (US)

(21) Appl. No.: 14/728,324

(22) Filed: Jun. 2, 2015

(51) Int. Cl. B23K 9/095; B23K 9/10

(52) U.S. Cl. CPC B23K 9/0953; B23K 9/1006

(57) ABSTRACT

Systems and methods for weld distortion reduction via a dynamically controlled heat source are disclosed. One system includes a welding apparatus comprising a sensor, a first heat source, and a second heat source. The system may further include a processor and a memory bearing instructions that, upon execution by the processor, cause the system at least to: receive data relating to a weld of a first part to a second part performed by the first heat source, the data comprising at least data from the sensor; generate, based at least on the data from the sensor, a simulation of the weld; determine, based at least on the simulation of the weld, a simulated distortion in at least one of the first part and the second part; determine, based at least on the determined simulated distortion, a heat source application intended to counter a distortion represented by the simulated distortion; and generate a directive to implement, by the second heat source, the heat source application.

### TECHNICAL FIELD

This disclosure relates generally to welding and more particularly to a system and method of weld distortion reduction via a dynamically controlled heat source.

### BACKGROUND

Welding may generally refer to the joining of two or more pieces of material, such as metal, using a heat source to melt the material, with or without an additional filler material, along the junction between the two pieces. By applying a heat source to the junction of the two pieces, a pool of molten material may be formed. When the pool of molten material cools, a strong bond may be formed between the two pieces.

An undesirable side effect of the welding process is weld distortion, which may be induced by the heating and cooling cycle of welding. When the stresses from the heating and cooling cycle exceed the yield strength of a welded material, deformation of the material may occur. Deformations caused by weld distortion may include longitudinal shrinkage, transverse shrinkage, angular distortion, bowing, dishing, buckling, and twisting. Weld distortion may negatively impact the quality of a welded product and cause other negative consequences, such as a poor fit in a subsequent assembly including the distorted material.

One method of reducing weld distortion is disclosed in U.S. Pat. No. 6,861,617 to Dull et al. (the '617 patent). The '617 patent describes a method in which transient thermal tensioning is used to create areas of tensile stress in a welded material that interrupt areas of compressive stress, thereby minimizing buckling in the welded material. The transient thermal tensioning may be induced by the application of a heat source at a pre-determined lateral distance from the weld location. The heat source may be moved in conjunction with the movement of a welding device.

Although the method described in the '617 patent may help to reduce weld distortion, the method does not dynamically monitor the effectiveness of the transient thermal tension in reducing distortion. Nor does the method described in the '617 patent adaptively control the movement, position, and/or intensity of the heat source used to induce the thermal tension during the welding process based on the ongoing monitoring of the weld operation. These and other shortcomings are addressed in the present disclosure.

### SUMMARY

This disclosure relates to systems and methods for weld distortion reduction via a dynamically controlled heat source. One system includes a welding apparatus comprising a sensor, a first heat source, and a second heat source. The system may further include a processor and a memory bearing instructions that, upon execution by the processor, cause the system at least to: receive data relating to a weld of a first part to a second part performed by the first heat source, the data comprising at least data from the sensor; generate, based at least on the data from the sensor, a simulation of the weld; determine, based at least on the simulation of the weld, a simulated distortion in at least one of the first part and the second part; determine, based at least on the determined simulated distortion, a heat source application intended to counter a distortion represented by the simulated distortion; and generate a directive to implement, by the second heat source, the heat source application.

In an aspect, a method includes receiving, by one or more processors, data relating to a weld of a first part to a second part performed by a welding apparatus, the data comprising at least data from a sensor of the welding apparatus; generating, by one or more processors, based at least on the data from the sensor, a simulation of the weld; determining, by one or more processors, based at least on the simulation of the weld, a simulated distortion in at least one of the first part and the second part; determining, by one or more processors, based at least on the determined simulated distortion, a heat source application intended to counter a distortion represented by the simulated distortion; and generating, by one or more processors, a directive to implement the heat source application.

In an aspect, a system includes a welding apparatus comprising a sensor, a first heat source, and a plurality of fixed heat sources. The system further includes a processor and a memory bearing instructions that, upon execution by the processor, cause the system at least to: receive data relating to a weld of a first part to a second part performed by the first heat source, the data comprising at least data from the sensor; generate, based at least on the data from the sensor, a simulation of the weld; determine, based at least on the simulation of the weld, a simulated distortion in at least one of the first part and the second part; determine, based at least on the determined simulated distortion, a heat source application intended to counter a distortion represented by the simulated distortion; and generate a directive to implement, by an activation of at least one of the plurality of fixed heat sources, the heat source application.

### BRIEF DESCRIPTION OF THE DRAWINGS

The following detailed description is better understood when read in conjunction with the appended drawings. For the purposes of illustration, examples are shown in the drawings; however, the subject matter is not limited to the specific elements and instrumentalities disclosed. In the drawings:

FIG. 1 illustrates a schematic side view of an exemplary welding apparatus in accordance with aspects of the disclosure;

FIG. 2 illustrates a schematic top view of an exemplary welding apparatus in accordance with aspects of the disclosure;

FIG. 3 illustrates a schematic side view of an exemplary welding apparatus in accordance with aspects of the disclosure;

FIG. 4 illustrates a schematic top view of an exemplary welding apparatus in accordance with aspects of the disclosure;

FIG. 5 illustrates a schematic diagram of an exemplary welding system in accordance with aspects of the disclosure;

FIG. 6 illustrates a block diagram of an exemplary data flow in accordance with aspects of the disclosure;

FIG. 7 illustrates a side view of a portion of an exemplary welding apparatus in accordance with aspects of the disclosure;

FIG. 8 illustrates a side view of a portion of an exemplary welding apparatus in accordance with aspects of the disclosure;

FIG. 9 illustrates a side view of a portion of an exemplary welding apparatus in accordance with aspects of the disclosure;

FIG. 10 illustrates a side view of a portion of an exemplary welding apparatus in accordance with aspects of the disclosure;

FIG. 11 illustrates a side view of a portion of an exemplary welding apparatus in accordance with aspects of the disclosure;

FIG. 12 illustrates a side view of a portion of an exemplary welding apparatus in accordance with aspects of the disclosure

FIG. 13 illustrates a flow chart of an exemplary method in accordance with aspects of the disclosure; and

FIG. 14 illustrates a block diagram of a computer system configured to implement the method of FIG. 13.

### DETAILED DESCRIPTION

This disclosure provides systems and methods for reducing weld distortion via a dynamically controlled heat source. In an aspect, a welding apparatus may be configured to perform a weld of two parts. The welding apparatus may include a plurality of clamps that secure the parts as they are being welded. Each of the clamps may contain a sensor that is able to detect a distortion in one of the parts, such as a weld distortion caused by the heat of the weld operation. The welding apparatus may include a counter heat source, such as gas flame on a movable robotic arm, that may be dynamically positioned to apply heat to a location on one of the parts that will cause a counter distortion in the part to negate the weld distortion caused by the weld operation.

A simulation of the weld operation may be generated based on data relating to the weld operation, such as the material, dimensions, and shape of the parts, the position and intensity of the heat applied, or to be applied, to perform the weld, and so forth. In the simulation, a weld distortion in one of the parts caused by the heat of the weld operation may be detected. An application of a counter heat source may be determined to induce a second distortion in the part that may negate or counter the weld distortion in the weld simulation. For example, if the heat from the weld operation causes an upward bowing weld distortion in one of the parts, an application of a counter heat source may be determined that will induce a downward bowing second distortion that may, preferably, negate the upward bowing weld distortion. The determined application of the counter heat source may be implemented, such as by the movable robotic arm with the attached counter heat source moving to a specified position on the part and applying heat. The actual weld operation, or portion thereof, may, in some aspects, be performed concurrently to the counter heat source being determined and applied to the part. In other aspects, the weld operation, or portion thereof, may be performed before or after the counter heat source being determined and applied to the part.

In an aspect, as the weld operation progresses, the weld simulation may be continuously updated with new data. For example, the sensors contained in the clamps of the welding apparatus may monitor and detect new weld distortions or distortions that remain after a counter heat source was applied, such as if, due to an imperfection in the material of the part, weld joint variation, or simulation inaccuracy, the prior counter heat source was inaccurately determined and the prior counter distortion failed to completely negate the prior weld distortion. In such an instance, the new data reflecting the remaining distortion may be used to update the weld simulation, which in turn may be used to determine a new counter heat source, which may be implemented, and so forth. The process may be repeated until the weld operation is concluded.

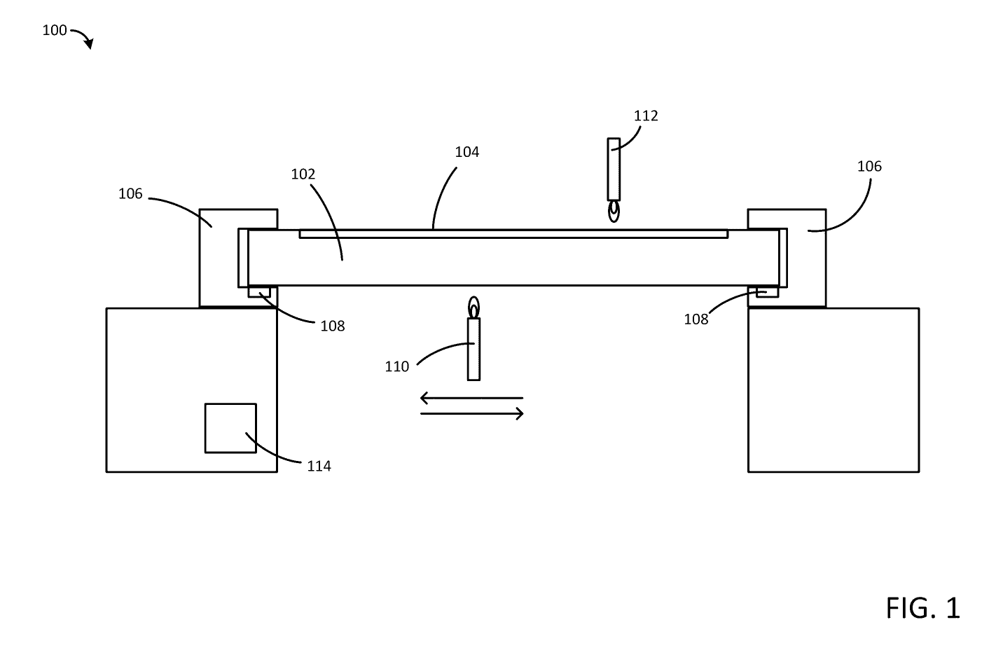

FIG. 1 shows a side view of an exemplary welding apparatus 100 that may be used to weld together two or more parts 102 (of which only one of the parts 102 is visible in FIG. 1). The welding apparatus 100 may include a welding heat source 112 to generate heat for the welding operation. The heat from the welding heat source 112 may be applied to a weld joint 104 disposed between two or more parts 102. As used herein, the weld joint 104 may refer to a joint between two of the parts 102 along which at least a portion of the joint is welded, is being welding, or will be welded. The welding heat source 112 may include any manner of heat source known in the art to be used in welding, including but not limited to a gas flame, an electric arc, a laser, or an electron beam. The welding heat source 112 may be movable, for example attached to a movable arm, to enable the welding heat source 112 to be moved along a particular path, such as a path corresponding to the weld joint 104, to perform the weld.

The welding apparatus 100 may include one or more clamps 106 in which the parts 102 may be securely held while being welded. The clamps 106 may be positioned in a variety of configurations, including along two opposite sides of the adjoining parts 102 or along all sides of the adjoining parts 102. The clamps 106 may be positioned along an edge(s) of the adjoining parts 102 parallel to the weld joint 104, normal to the weld joint 104, or in any other orientation.

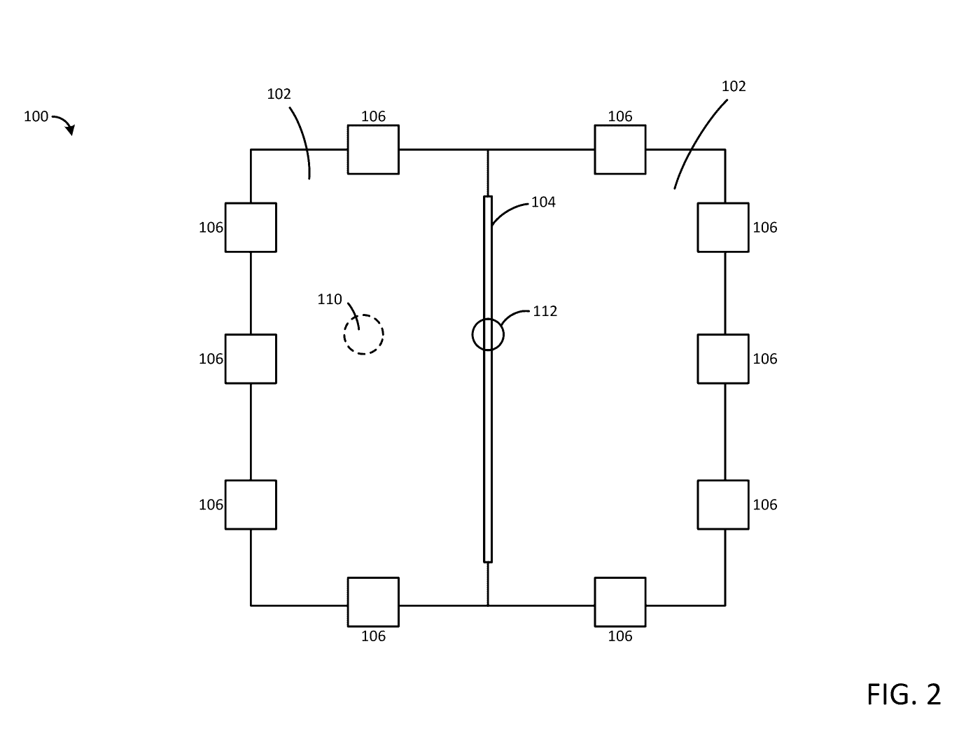

FIG. 2 shows a top view of the welding apparatus 100, including the parts 102 and the weld joint 104. As shown, the clamps 106 are positioned at intervals along all four edges of the adjoining parts 102. As discussed herein, the invention is not so limited and the clamps 106 may positioned in a variety of configurations. The welding heat source 112 is depicted as being positioned above the parts 102 and the counter heat source 110 is shown in dashed lines to represent that the counter heat source 110 is positioned below the parts 102.

Returning to FIG. 1, the welding apparatus may include one or more sensors 108. One or more of the sensors 108 may be incorporated within or disposed in or on one or more of the clamps 106. The sensor 108 may be configured to detect movement or distortion of the parts 102. For example, the sensor 108 may be a force sensor, such as a sensor configured to detect a downward force at the clamp-side edge of the part 102 caused by an upward bowing distortion at a middle portion of the part 102, or vice versa. As another example, the sensor 108 may include a lateral force sensor configured to detect if the part 102 moves laterally within the clamp 106 (e.g., the part 102 is pulled in the direction out of the clamp 106), such as if longitudinal or transverse shrinkage distortion occurs.

The sensor 108 may further include a dimensional or distance sensor capable of detecting a change in distance between the sensor 108 and a certain portion of the part 102. For instance, if a portion of the part 102 buckles upward, a distance or dimensional sensor may detect the resulting displacement. In an aspect, one or more distance or dimensional sensors, or other type of sensor, may be used to track the dimensional attributes of the parts 102, which may thereby be used to create a virtual representation, such as a three-dimensional digital map, of the part 102. In some aspects, the sensor 108 may be disposed separately from the clamp 106. In other aspects, some sensors 108 may be incorporated into the clamp 106, such as shown in FIG. 1, while other sensors 108 may be disposed separately from the clamp 106.

The welding apparatus 100 may include a counter heat source 110 that may be used to induce a second distortion, i.e., a counter distortion, to counter the weld-induced distortion. The counter distortion may be an induced distortion in one of the parts 102 that, when combined with a weld distortion in the part 102 caused by the weld operation, results in the part 102, or a portion thereof, exhibiting an undistorted or otherwise desirable shape and/or dimensions. For example, a counter distortion in one of the parts 102 may be a distortion in the opposite direction and of an equal magnitude as a weld distortion in the part 102. As a result of the combined distortions, the part 102 may be flat, as desired. The counter heat source 110 may include an induction heating element, a gas flame, an electric arc, or any other type of heat source known in the art. In an aspect, the counter heat source 110 may be positioned on the opposite side of the parts 102 as the welding heat source 112. For example, the welding heat source 112 may be positioned on the top side of the parts 102 and the counter heat source 110 may be positioned on the bottom side of the parts 102, as shown in FIG. 1.

The counter heat source 110 may be movable during the welding operation, thus allowing the creation of the counter distortion to move in cooperation with the movement of the welding heat source 112 and/or allowing the counter distortion to be dynamically adjusted. As an example of dynamic adjustment, the shape of the parts 102 and any distortions therein may be continually monitored, such as by the sensors 108, during the weld operation and the position and/or movement of the counter heat source 110 may be adjusted if the current position of the counter heat source 110 is failing to induce counter distortions that completely negate the weld distortions. As an example, the counter heat source 110 may be attached to a robotic arm.

The welding apparatus 100 may include a control module 114 configured to collect, store, and/or process data from the sensors 108 or other sources, control the welding heat source 112, control the counter heat source 110, and/or operate the clamps 106. The control module 114 may include a processor and memory and may be configured to communicate with an offboard controller to, for example, transmit data from the sensors 108, relay data concerning the operation of the welding apparatus 100, and/or receive instruction for the operation of the welding apparatus 100.

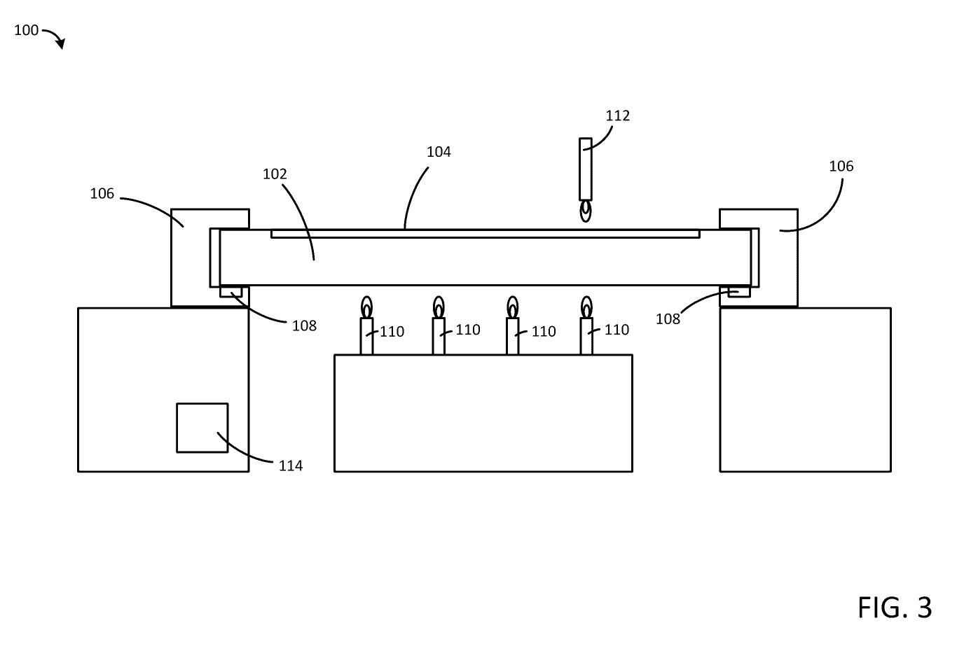

FIG. 3 shows a side view of an exemplary embodiment of the welding apparatus 100. In some aspects, the welding apparatus 100 may include a plurality of counter heat sources 110 in fixed positions. The plurality of counter heat sources 110 may be configured in a line, a two-dimensional grid, or other configuration. As a weld operation is performed, one or more of the counter heat sources 110 may be activated to induce a counter distortion in the part 102 at the location of that counter heat source(s) 110.

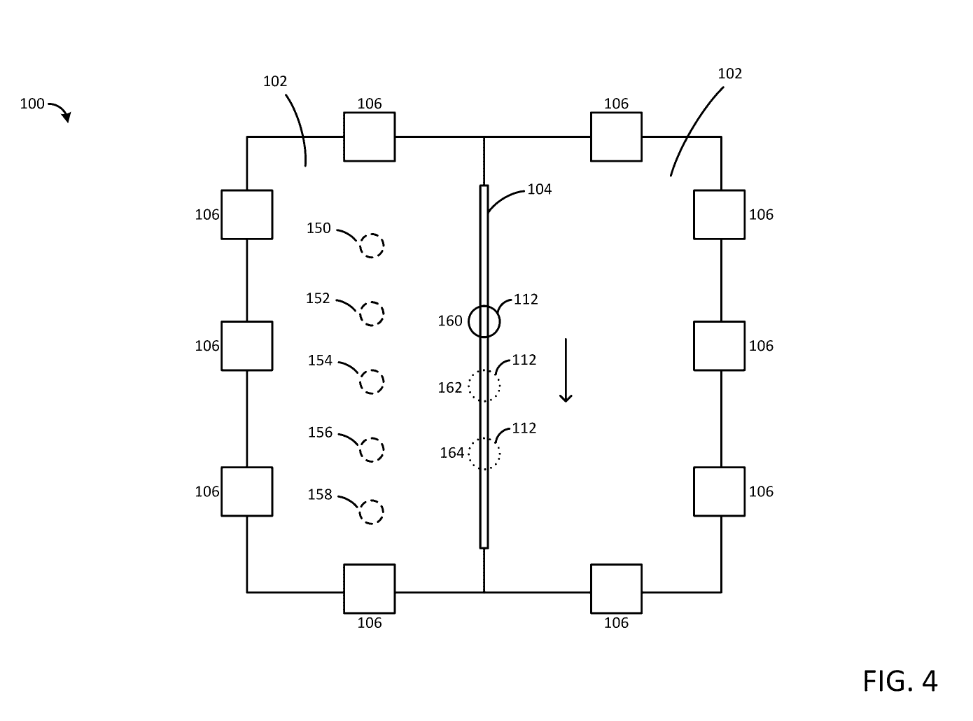

Referring to FIG. 4, for example, an array of counter heat sources 110, including counter heat sources 150, 152, 154, 156, and 158, is disposed beneath one of the parts 102. The counter heat sources 150, 152, 154, 156, and 158 are shown using dashed lines to reflect that the counter heat sources 150, 152, 154, 156, and 158 are positioned below the parts 102 in the illustrated example. A weld operation may be performed along the weld joint 104 by the welding heat source 112 sequentially moving from position 160 to position 162 and from position 162 to position 164. The welding heat source 112 at positions 162 and 164 is shown using dotted lines to reflect the welding heat source's 112 movement to those positions. In order to induce a counter distortion for the weld distortion caused by heat from the welding heat source 112 at position 160, the counter heat source 152 may be activated, as indicated by the grayed-out state of the counter heat source 152 shown in the illustrated example. As the weld operation progresses and the welding heat source 112 moves to position 162, the counter heat source 152 may be deactivated and the counter heat source 154 may be activated. Similarly, as the welding heat source 112 moves to position 164, the counter heat source 154 may be deactivated and the counter heat source 156 may be activated. In this manner, the selective activation of the counter heat sources 110 of the plurality of counter heat sources 110 may perform a similar function as the single movable counter heat source 110.

In some aspects, more than one counter heat source 110 may be simultaneously activated and/or one or more counter heat sources 110 may be partially activated. For instance, as the welding heat source 112 moves from position 160 to position 162, the counter heat source 152 may be reduced, for example, to half power and the counter heat source 154 may be activated at full power.

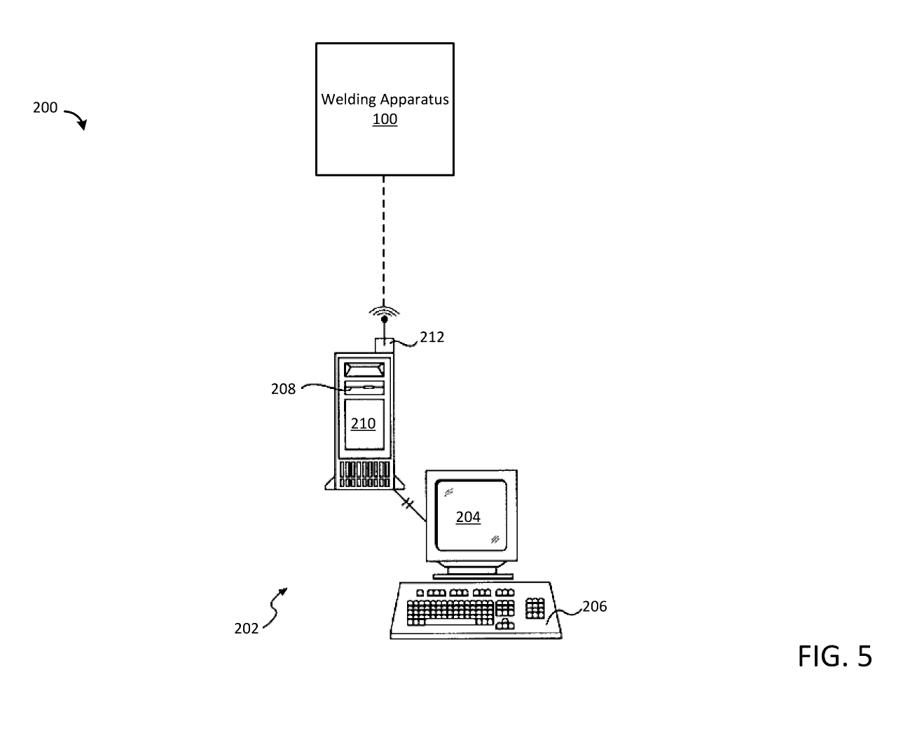

FIG. 5 is a schematic illustration of a welding system 200, including the welding apparatus 100 and a communicatively connected controller 202. The controller 202 may be configured to generate a simulation of a welding operation of the welding apparatus 100, determine a resultant weld distortion, determine a second counterbalancing distortion to be induced, and instruct the control module 114 of the welding apparatus 100 to execute operations that will induce the counterbalancing distortion. The controller 202 may interface with the control module 114 of the welding apparatus 100 to receive data pertaining to the weld operation occurring thereon, including data from the sensors 108 and data concerning the operation of the welding heat source 112 and the counter heat source 110. The controller 202, in turn, may transmit instructions to the control module 114, particularly pertaining to the operation of the welding heat source 112 and the counter heat source 110.

The controller 202 may include any type of computer or plurality of computers networked together. The controller 202 may be incorporated within the welding apparatus 100 or may be separate from the welding apparatus 100. The controller 202 may include, among other things, a console 204, an input device 206, an input/output device 208, a storage media 210, and a communication interface 212. The console 204 may be any appropriate type of computer display device that provides a user interface, such as a graphical user interface (GUI), to display results and information to operators and other users of the welding system 200.

The input device 206 may be configured to enable operators to input information into the controller 202. The input device 206 may include, for example, a keyboard, a mouse, touch screen, joystick, voice recognition, or another computer input device. The input/output device 208 may be any type of device configured to read/write information from/to a portable recording medium. The input/output device 208 may include among other things, a floppy disk, a CD, a DVD, a flash memory read/write device or the like. The input/output device 208 may be provided to transfer data into and out of the controller 202 using a portable recording medium. The storage media 210 could include any means to store data within the controller 202, such as a hard disk. The storage media 210 may be used to store a database containing, among others, data from the sensors 108 reflecting one or more distortions and other data representing a welding process. The communication interface 212 may provide connections with the control module 114 of the welding apparatus 100 and enable the controller 202 to be remotely accessed through computer networks, and means for data from remote sources to be transferred into and out of the controller 202. The communication interface 212 may contain network connections, data link connections, and/or antennas configured to receive wireless data.

Data may be transferred to the controller 202 electronically or manually. Electronic transfer of data may include the remote transfer of data using the wireless capabilities or the data link of the communication interface 212 by a communication channel as defined herein. Data may also be electronically transferred into the controller 202 through a portable recording medium using the input/output device 208. Manually transferring data into the controller 202 may include communicating data to a welding system 200 operator in some manner, for example verbally, such that the operator may then manually input the data into the controller 202 by way of, for example, the input device 206. The data transferred into the controller 202 may include, for example, weld system data and data pertaining to a past, ongoing, or future weld process.

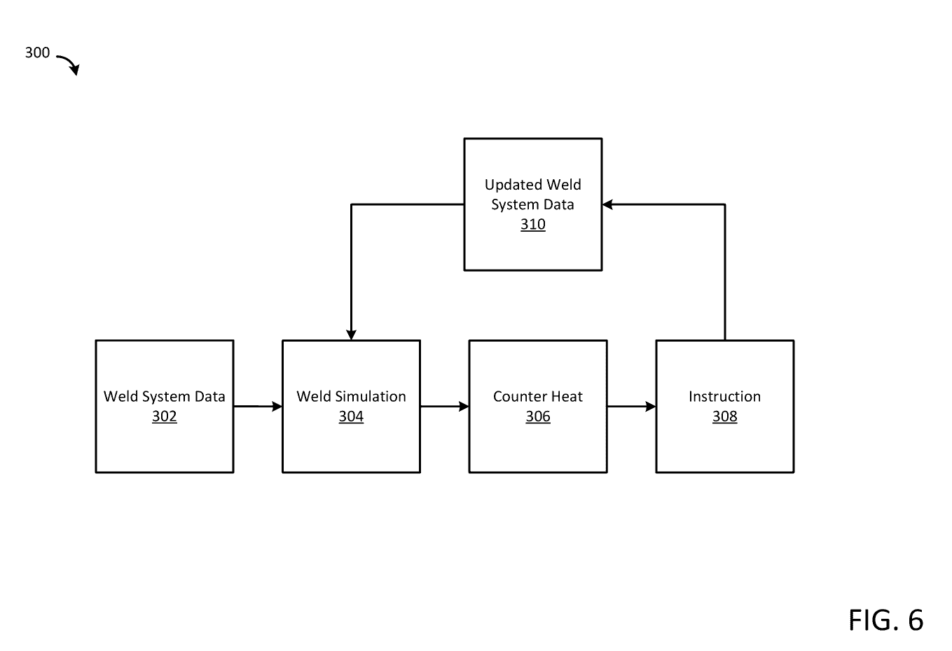

FIG. 6 depicts an example flow diagram 300 of various operations relating to systems and methods for weld distortion reduction via a dynamically controlled heat source. In an aspect, a weld simulation 304 may be determined by, for example, the controller 202. The weld simulation 304 may simulate a process, or portion of a process, of creating a weld with the welding apparatus 100, i.e., the weld operation. For example, the weld simulation 304 may simulate the movement of the welding heat source 112 along the weld joint 104, the application of heat via the welding heat source 112, the creation of a molten pool at the weld joint 104, and the subsequent cooling of the molten pool to form the weld. The weld simulation 304 may further simulate the stresses within the parts 102 and any distortions that may occur in the parts 102 as a result of the welding process. It will be appreciated that the weld simulation 304 may include a simulation of past welding apparatus 100 operations, current welding apparatus 100 operations, and/or future welding apparatus 100 operations.

The weld simulation 304 may include the generation and/or modification of a model of the weld operation and various aspects thereof. The model may further be executed to predict, concurrently represent, or recreate the weld operation. The model may include various algorithms and/or equations that represent the weld operation and/or various aspects thereof. For example, the model may include an algorithm in which data concerning the properties of the material composing the parts 102 and the temperature of the welding heat source 112 are input and data representing a resulting tensile stress in the parts 102 may be output. The model may further include an algorithm that uses the data representing the tensile stress and outputs geometrical data representing a distortion.

The weld simulation 304 may be based on weld system data 302. The weld system data 302 may include data pertaining to the configuration of the welding apparatus 100. For example, the welding apparatus 100 configuration data may include a number and positioning of the clamps 106, an identification of the sensors 108, including the sensors' 108 type(s) and locations, an identification of the welding heat source 112 and associated properties (e.g., type, heat production potential, heat-up time, etc.), and an identification of the counter heat source 110 and associated properties (e.g., type, heat production potential, heat-up time, etc.). The weld system data 302 may include data on the parts 102 to be welded, such as a material composition of the parts 102, the dimensions of the parts 102, the shape of the parts 102, and the positioning of the parts 102 within the welding apparatus 100. The data relating to the parts 102 may further include information on the properties of the material of the parts 102, such as a factor relating to thermal transmission, stiffness, resilience to compressive or tensile stress, retention of residual stress, and/or propensity to distort. The welding apparatus 100 configuration data may be provided by the welding apparatus 100, such as via the control module 114 or the sensors 108, or other source, such as operator input via the input device 206 of the controller 202.

The weld system data 302 may further include data pertaining to the welding operation, which may reflect a past, current, or planned welding operation. Welding operation data may include a position and/or movement of the welding heat source 112 and/or a position and/or movement of the counter heat source 110. The welding operation data may include data pertaining to a power or intensity of the heat from the welding heat source 112 and/or the counter heat source 110, the duration of application of said heat, and/or the proximity of the welding heat source 112 or the counter heat source 110 to the parts 102. As the position and/or movement of the welding heat source 112 and/or the counter heat source 110 may be included in the weld system data 302, so too may a position and/or movement of a heated location on the parts 102 be included in the weld system data 302. The welding process data may be recorded by and transmitted from the control module 114 of the welding apparatus 100.

The weld system data 302 may additionally include data reflecting a distortion in one or more of the parts 102. For example, the distortion data may include an indication that a portion of one of the parts 102 is raised or depressed relative to the rest of the part 102. As another example, the distortion data may include an indication that one or more dimensions of one of the parts 102 has changed. As a further example, the distortion data may include an indication that the shape of one or more of the parts 102 has changed. The distortion data may be derived from the sensors 108 of the welding apparatus 100, such as a force sensor incorporated within one of the clamps 106 detecting a downward force upon the force sensor produced by an upward buckling of a portion of one of the parts 102.

As part of the weld simulation 304, a determination may be made that a distortion in one of the parts 102 has occurred, is occurring, or will occur. For example, a simulated weld may be performed. As the simulated welding heat source 112 moves along the simulated weld joint 104, the simulated heat may cause a portion of one of the simulated parts 102 to deform in an upward buckle. The distortion may be determined by a comparison of the dimensions or shape of the actual part 102 before welding, as included in the weld system data 302, and the dimensions of the simulated part 102. For instance, if the part 102 before welding was a flat panel, a distortion may be detected in the simulated part 102 by a detection that a portion of the simulated part 102 is raised relative to the flat plane of the rest of the simulated part 102. In an aspect, a two- or three-dimensional virtual representation of the parts 102 may be created as part of the weld simulation 304. The weld simulation 304 may include an analysis, such a finite element analysis, of the simulated stress effects upon the virtual representation of the parts 102 caused by the welding process and may determine a distortion based upon said analysis.

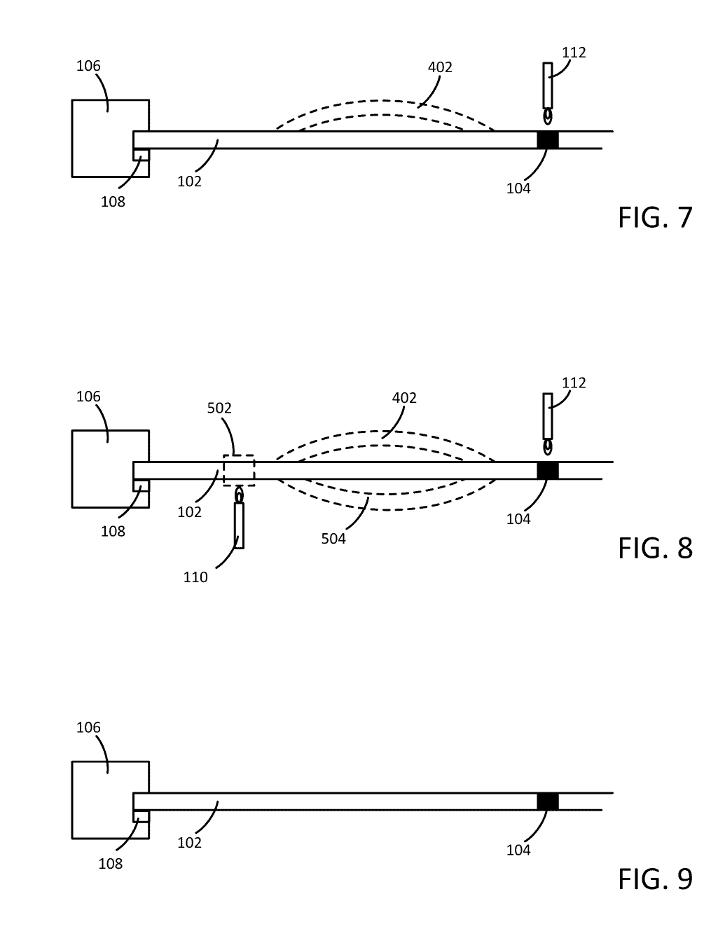

Referring to FIG. 7, a side view of a simulated weld involving the simulated part 102 is shown. The simulated welding heat source 112 is applied to the simulated weld joint 104. Due to the heat from the simulated welding heat source 112, a simulated weld distortion 402 is determined. For example, the simulated weld distortion 402 may be determined using an algorithm within the weld simulation 304 that models the stress that would be induced in the part 102 as a result of the simulated welding heat source 112. Another algorithm within the weld simulation 304 may determine a simulated displacement within the part 102 that would be caused by stress. The simulated displacement may be compared to a virtual representation of the part 102 in the weld simulation 304 to determine that the simulated displacement represents a weld distortion, such as the simulated weld distortion 402.

Referring back to FIG. 6, based at least on the weld simulation 304, a counter heat 306 and various aspects thereof may be determined. The counter heat 306 is intended to counteract a distortion determined in the weld simulation 304. For example, the counter heat 306 may induce a counter distortion that serves to negate the distortion caused by the heat of the welding heat source 112. The counter heat 306 may be generated by one or more counter heat sources 110. Aspects of the counter heat 306 that may be determined include a location and/or movement of the counter heat 306 on the part 102. Since the welding heat source 112 may move along the weld joint 104, the counter heat 306 (and therefore the counter heat source 110) may move in coordination with the welding heat source 112.

Another aspect of the counter heat 306 may be the intensity and/or size of the counter heat 306. The intensity (e.g., temperature) and/or size of the counter heat 306 may be varied according to the power or intensity of the counter heat source 110 and/or the proximity of the counter heat source 110 to the part 102. The determination of the counter heat 306 may include an analysis, such as a dimensional or spatial analysis, of a distortion modeled in the weld simulation 304, including a magnitude (e.g., the distance between a distortion, or portion thereof, and an undistorted plane of the part 102), shape, and/or location of the distortion. For example, if a distortion has an upward magnitude of 10 mm, the counter heat 306 may be determined that produces a counter distortion with a downward magnitude of 10 mm. In an aspect, the counter distortion to counteract the weld distortion may first be determined, based at least on the determination of the weld distortion, and the counter heat 306 may be determined based on and to effectuate the determined counter distortion.

FIG. 8 depicts a side view of the simulated weld shown in FIG. 7, including the weld distortion 402 caused by the heat of the welding heat source 112. In order to counteract the weld distortion 402, a counter heat 502 (an instance of the counter heat 306) is determined, including the location of the counter heat 502 on the part 102. The counter heat 502 may be created by the counter heat source 110. The counter heat 502 may produce a second distortion 504 that includes, as determined by the weld simulation 304, a downward bowing of the part 102. Since the downward bowing of the second distortion 504 is opposite the upward bowing of the part 102 in the weld distortion 402 and of an equal magnitude to that of the weld distortion 402, the second distortion 504 may negate the weld distortion 402. FIG. 9 shows the simulated shape of the part 102 of FIGS. 7 and 8 after the counter heat 502 is applied. As can be seen, the weld distortion 402 and the second distortion 504 negate each other and the part 102 is flat, as it was before the welding process.

Referring again to FIG. 6, an instruction 308 may be generated based on the determination of the counter heat 306. The instruction 308 may be generated by the controller 202 and further transmitted to the control module 114 of the welding apparatus 100. The instruction 308 may include one or more instructions or directives pertaining to the operation of the counter heat source 110 and may be intended to direct the counter heat source 110 to effectuate the determined counter heat 306. For example, the instruction 308 may include an instruction or directive for a robotic arm with the counter heat source 110 attached to move to a particular position on one of the parts 102 (e.g., a set of X-Y coordinates in a coordinate grid established for the surface of the part 102) and for the counter heat source 110 to apply its heat at a particular intensity (e.g., temperature).

In aspects wherein the welding apparatus 100 includes a plurality of fixed counter heat sources 110 instead of a movable counter heat source 110, the instruction 308 may include an instruction or directive specifying one or more of the plurality of counter heat sources 110 to be activated at a specified intensity for a specified time interval. The counter heat source 110 creating the counter distortion may be applied before the weld is performed, concurrent to the weld being performed, or after the weld is performed. Therefore, in some aspects, the instruction 308 may further include an instruction or directive for the weld, or portion thereof, to be created, such as for the welding heat source 112 to apply heat to the weld joint 104. In other aspects, an instruction or directive for the weld to be created may be transmitted as a separate instruction or directive from the instruction 308.

Upon receipt of the instruction 308, the welding apparatus 100 may generate the counter heat 306 in one of the parts 102 according to the instruction 308. For example, the counter heat source 110 may be positioned at the location of the counter heat 306 specified in the instruction 308 and apply heat at a specified level at the location to create the counter heat 306. The counter heat 306 may induce a distortion that counteracts a distortion that is created, or will be created, by the welding process.

Updated weld system data 310 may be received by, for example, the controller 202. The updated weld system data 310 may be received after the instruction 308 is implemented by the welding apparatus 100 and, in an aspect, after a portion of the weld process has begun. The updated weld system data 310 may include any type of data included in the weld system data 302 and updated, if applicable, according to a current status of the welding apparatus 100 and components thereof, the parts 102, and/or the weld joint 104. For example, if the welding heat source 112 had moved along the weld joint 104 as part of performing the weld, the updated position of the welding heat source 112 may be included in the updated weld system data 310. Similarly, if the counter heat source 110 had moved, the updated position of the counter heat source 110 may be included in the updated weld system data 310.

The updated weld system data 310 may further include data relating to the counter heat 306, a weld distortion caused by the heat of the weld, a counter distortion caused by the counter heat 306, and/or a distortion that results from the interaction of the weld distortion and the counter distortion. For example, the updated weld system data 310 may include a position, size, and/or shape of an aforementioned distortion. The position, size, shape, or other aspect of a distortion may be detected by one or more of the sensors 108. A distortion resulting from the interaction of the weld distortion and the counter distortion may be, for example, a side effect of an imprecision or imperfection in the weld simulation 304 or the welding apparatus 100, an unknown irregularity in the material of the parts 102, and so forth.

The updated weld system data 310 may be used to update the weld simulation 304 or generate a new weld simulation. A new counter heat may be determined based on the updated weld simulation 304 or the new weld simulation. For example, as the weld progresses, a new weld distortion and/or simulation of a weld distortion may be detected in the updated weld simulation 304 and a new counter heat may be determined to create a counter distortion to negate the new weld distortion. As another example, a new distortion may be detected in the updated weld simulation 304 that is the result of an interaction between a prior weld distortion and a prior counter distortion, such as if the prior counter distortion failed to completely eliminate the prior weld distortion. A new counter heat may be determined to create a new counter distortion to counteract the new distortion.

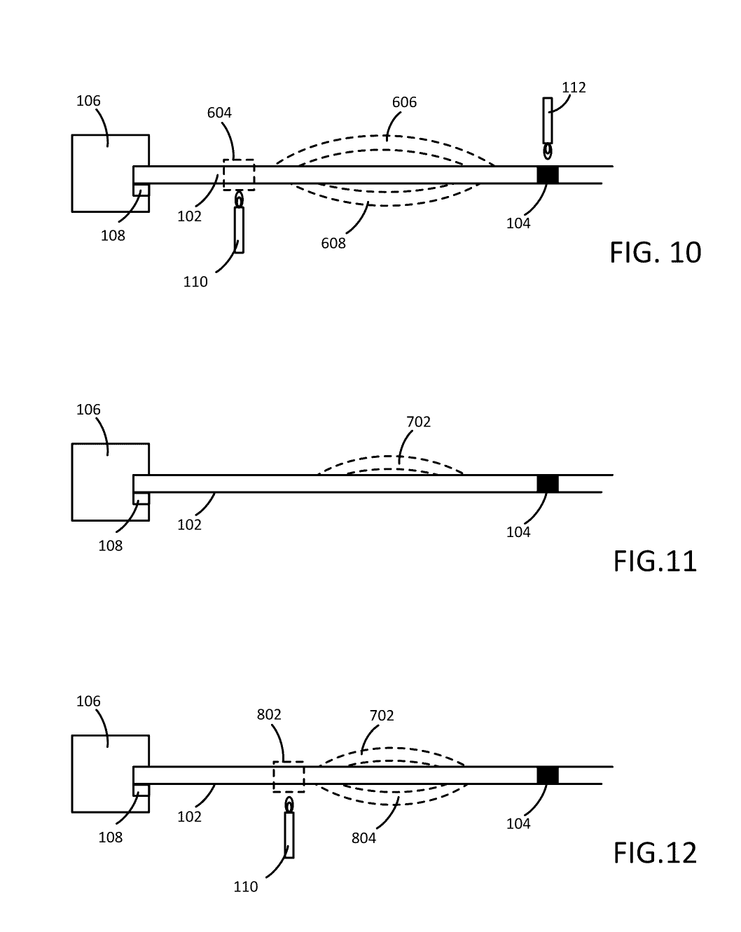

As an example, FIG. 10 depicts a portion of the welding apparatus 100 after a portion of the weld has been performed. A weld distortion 606 has been caused by the heat from the welding heat source 112. In an attempt to counteract the weld distortion 606, a counter heat 604 has been determined. The counter heat 604 may have been determined based on an analysis of the simulated representation or model of the weld distortion 606 in the weld simulation 304. For example, the shape, dimensions, and/or magnitude of the simulated representation or model of the weld distortion 606 may have been considered in determining the counter heat 604 that was intended to negate the weld distortion 606. The counter heat source 110 has been applied to the part 102 to effectuate the counter heat 604. A counter distortion 608 has been caused by the counter heat 604.

Referring now to FIG. 11, which depicts the portion of the welding apparatus 100 of FIG. 10, a distortion 702 is formed resulting from the interaction of the weld distortion 606 and the counter distortion 608. The distortion 702 is formed since the counter distortion 608 was of lesser magnitude than the weld distortion 606 and thus the counter distortion 608 was insufficient to negate the weld distortion 606. The distortion 702 may be detected by one or more of the sensors 108 and the distortion 702 and its properties (e.g., dimensions, location on the part 102, etc.) may be reflected in the updated weld system data 310. The updated weld system data 310, including the data pertaining to the distortion 702, may be used to update the weld simulation 304.

Referring to FIG. 12, which shows the portion of the welding apparatus 100 of FIGS. 10 and 11, based on the updated weld simulation 304, a counter heat 802 (distinct from the counter heat 604 shown in FIG. 10) is determined and generated by the correspondingly positioned counter heat source 110. The counter heat 802 may be determined based on an analysis of one or more aspects (e.g., magnitude, dimension, shape, and/or location) of the distortion 702 in the weld simulation 304. For instance, if the distortion 702 has a upward magnitude of 5 mm and a dimension of 10 cm by 10 cm, the counter heat 802 may be determined that results, in the weld simulation 304, of a corresponding distortion that has a downward magnitude of 5 mm and dimensions of 10 cm by 10 cm. The counter heat 802 causes a counter distortion 804 to be induced that is intended to counteract and negate the distortion 702, thus rendering the part 102 or that portion of the part 102 flat (or other shape of which the part 102 is intended to maintain or be formed). In the event that the counter heat 802 fails to render the part 102 flat or other desirable shape, such as if a distortion remains in the part 102, the process may be repeated one or more times: the remaining distortion may be detected by one or more of the sensors 108 and input into an updated weld simulation, a new counter heat may be determined to counteract the remaining distortion, and so forth.

### INDUSTRIAL APPLICABILITY

The industrial applicability of the systems and methods for reducing weld distortion via a dynamically controlled heat source described herein will be readily appreciated from the foregoing discussion.

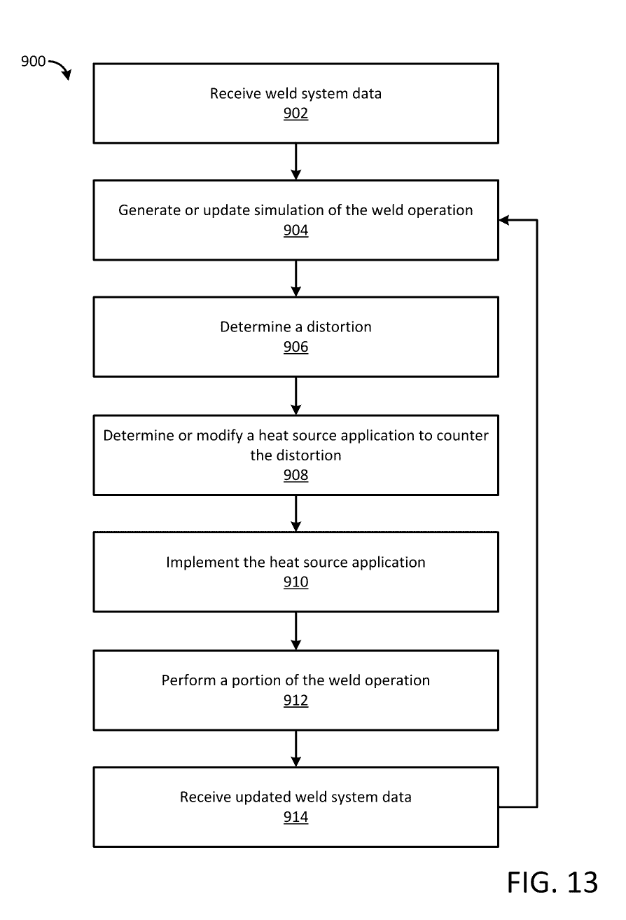

FIG. 13 illustrates a process flow chart for a method 900 for reducing weld distortion via a dynamically controlled heat source. For illustration, the operations of the method 900 will be discussed in reference to FIGS. 1-5. At step 902, weld system data 302 may be accessed or received. The weld system data 302 may be accessed or received by the controller 202. The weld system data 302 may be accessed or received from the welding apparatus 100, such as from the control module 114 or one or more of the sensors 108 of the welding apparatus 100. The weld system data 302 may further be accessed or received from the storage media 210 of the controller 202 or input by an operator into the controller 202.

The weld system data 302 may include any data related to the configuration of the welding apparatus 100, such as a number and positioning of the clamps 106, an identification of the sensors 108 and their type(s) and location(s), an identification of the welding heat source 112 and associated properties, and an identification of the counter heat source 110 and associated properties. The weld system data 302 may further include data describing the parts 102, such as material (and properties thereof), dimensions, shape, weld joint configuration, and positioning.

The weld system data 302 may additionally include data concerning the welding operation, including a past, current, or planned weld operation. For example, the weld system data 302 may include data reflecting a position and/or movement of the welding heat source 112 and/or the counter heat source 110. The weld system data 302 may include data reflecting a power or intensity of the heat from the welding heat source 112 and/or the counter heat source 110, the duration of the application of the heat, and/or the proximity of the welding heat source 112 or the counter heat source 110 to the parts 102.

The weld system data 302 may further include data related to a distortion in one or more of the parts 102, such as an indication that a portion of one of the parts 102 is raised or depressed relative to the rest of the part 102, one or more dimensions of one or more of the parts 102 has changed, and/or the shape of one or more of the parts 102 has changed.

At step 904 and based at least in part on the weld system data 302, the weld simulation 304 may be generated or, in the event that the weld simulation 304 was previously created, the weld simulation 304 may be updated. The weld simulation 304 may simulate an operation, or portion of an operation, of creating a weld with the welding apparatus 100. Accordingly, the weld simulation 304 may simulate the operation of the welding apparatus 100 and various components thereof (e.g., the clamps 106, the welding heat source 112, and/or the counter heat source 110), and the results of said operation, such as the creation of a molten pool at the weld joint 104, the heat within one or more of the parts 102, and/or a distortion in on or more of the parts 102. The weld simulation 304 may simulate a planned weld operation, a present weld operation, or a past weld operation.

At step 906 and based at least in part on the weld system data 302 and/or the weld simulation 304, a distortion in one or more of the parts 102 may be determined to have occurred, to be presently occurring, or to occur in the future. The distortion may be caused by, or will be caused by, the heat from the weld process, such as from the welding heat source 112. In an aspect, the determination of the distortion may include a comparison between the dimensions and/or shape of one or more parts 102 before a weld operation is performed and the dimensions and/or shape of the part 102 after the weld operation (or simulation thereof) is performed. The distortion may be represented by a shape, a size, dimensions, and/or a magnitude (e.g., the distance between a plane of the part 102 and the most distal portion of the distortion). It will be appreciated that the distortion referred to with respect to step 906 may comprise an actual distortion or a simulated distortion.

At step 908 and based at least in part on the weld system data 302, the weld simulation 304, and/or the determination of the distortion, a heat source application, such as the counter heat 306, is determined or modified. The counter heat 306 is intended to induce a counter distortion that counteracts or negates the distortion caused by the heat from the welding process and determined in step 906. Aspects of the counter heat 306 may include a position on one of the parts 102, a movement, a size, and/or an intensity. As an example, if the distortion determined in step 906 comprises an upward bowing of a portion of one of the parts 102, the counter heat 306 may be determined so that the resulting counter distortion comprises a downward bowing of the portion of the part 102. Preferably, the counter heat 306 is determined so that the upward bowing of the distortion would be negated by the opposite downward bowing of the counter distortion.

At step 910, the heat source application, such as the counter heat 306, may be implemented by the welding apparatus 100. As part of the implementation, the instruction 308 may be generated that directs the welding apparatus 100 to effectuate the counter heat 306. For example, the instruction 308 may include a position and heat intensity for the counter heat source 110 to move to and produce heat at that intensity. The instruction 308 may be generated and transmitted by the controller 202 and received by the welding apparatus 100, such as the control module of the welding apparatus 100. The welding apparatus 100 may effectuate the instruction 308. Continuing the preceding example, the counter heat source 110 may move to the position specified in the instruction 308 and produce heat (e.g., operate the counter heat source's 110 gas flame or induction element) at the specified intensity.

At step 912, a portion of the weld operation may be performed. For example, the welding heat source 112 may operate to create a pool of molten material at the weld joint 104. It will be appreciated that step 912 may be performed before, after, or concurrent to all or some of steps 902-910.

As an example, step 912 may be performed before steps 902, 904, 906, 908, 910, and 912. In such an instance, a portion of the weld operation may be performed, such as the welding heat source 112 creating a molten pool at the weld joint 104, which in turn may cause a weld distortion in one of the parts 102. The weld distortion may be indicated in the weld system data 302 of step 902, reflected in the weld simulation 304 of step 904, and determined to have occurred in step 906. In step 908, the counter heat 306 may be determined to induce a counter distortion to negate the weld distortion and in step 910 the counter heat 306 may be implemented by the welding apparatus 100.

As an example, step 912 may be performed after all of steps 902, 904, 906, 908, and 910 have been performed. In such an instance, the weld system data 302 of step 902 may include a plan to perform a portion of the weld operation (e.g., the welding heat source 112 is projected to create a molten pool at the weld joint 104). The weld simulation 304 of step 904 may simulate the weld operation. In step 906, it may be determined that the weld operation, when performed, will cause a weld distortion. In step 908, the counter heat 306 may be determined that will cause a counter distortion to counteract the future weld distortion. In step 910, the counter heat 306 may be implemented to cause the counter distortion. In step 912, the planned portion of the weld operation may be performed.

In an aspect, step 912 may be performed concurrent to one or more of steps 902, 904, 906, 908, and 910. For example, steps 902, 904, 906, and 908 may be performed based on a planned future weld operation. However, step 910 to implement the counter heat 306 and step 912 to perform the portion of the weld operation may be performed concurrently. That is, the welding heat source 112 may operate to perform the weld operation while the counter heat source 110 concurrently operations to counter the weld distortion caused by the weld operation. As another example, steps 902, 904, 906, 908, and 910 may be performed concurrently to step 912, such as in a method in which steps 902, 904, 906, 908, and 910 are performed in real-time to the weld operation of step 912. In such a method, the weld simulation 304 of step 904 may be repeatedly updated with real-time weld system data 302 of step 902 and the counter heat 306 of step 908 is determined and implemented in real-time to counter the concurrently produced weld distortion.

At step 914, updated weld system data 310 may be accessed or received by, for example, the controller 202. The updated weld system data 310 may be accessed or received from the welding apparatus 100, such as from one or more of the sensors 108 and/or the control module 114. The updated weld system data 310 may be accessed or received from the storage media 210 of the controller 202 or input by an operator into the controller 202. The updated weld system data 310 may include any type of data included in the weld system data 302 and may be updated, if applicable, with new data reflecting a current status of the welding apparatus 100 and components thereof, the parts 102, and/or the weld joint 104. For example, the updated weld system data 310 may indicate an updated position of the welding heat source 112 and the counter heat source 110 in accordance with steps 910 and 912. The updated weld system data 310 may additionally include data (e.g., size, position, shape, magnitude, etc.) reflecting the counter heat 306, a weld distortion caused by the heat of the weld, a counter distortion caused by the counter heat 306, and/or a distortion that results from the interaction of the weld distortion and the counter distortion.

Steps 904, 906, 908, 910, 912, 914, and any combination thereof may be iteratively repeated, for example, as the process of creating the weld continues. To illustrate, the updated weld system data 310 may be used to update the weld simulation 304 or generate a new weld simulation, which in turn may be used to determine a distortion. The distortion may be a distortion that was not completely negated in a prior iteration of steps 904-914 or the distortion may be a new weld distortion caused by the weld being further created (i.e. the welding heat source 112 has advanced along the weld joint 104, creating additional molten material, and a new weld distortion has been caused by the heat from the additional molten material and the welding heat source 112). A new heat source application, such as a new counter heat, may be determined to negate the new determined distortion. The new counter heat may be implemented, such as via an instruction from the controller 202 to the control module 114 of the welding apparatus 100. A portion of the weld operation may be performed, although it will be appreciated, as discussed herein, that the portion of the weld operation may be performed before, after, or concurrently to all or some of steps 904-910. In an aspect, step 912 may not be performed in all iterations of steps 904-914, such as when a prior iteration has failed to eliminate a distortion and the present iteration is attempting to eliminate that remaining distortion. A new counter distortion may be induced by the implemented counter heat, preferably negating the distortion. Steps 902-914 may be further repeated until all distortions are eliminated and/or the weld operation is concluded.

Whether such functionality is implemented as hardware or software depends upon the design constraints imposed on the overall system. The described systems and methods may be implemented in varying ways for each particular application, but such implementation decisions should not be interpreted as causing a departure from the scope of the disclosure. In addition, the grouping of functions within a module, block, or step is for ease of description. Specific functions or steps may be moved from one module or block without departing from the disclosure.

The various illustrative logical blocks and modules described in connection with the aspects disclosed herein may be implemented or performed with a general purpose processor, a digital signal processor (DSP), application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices, for example, a combination of a DSP and a microprocessor, a plurality of microprocessors, one or more microprocessors in conjunction with a DSP core, or any other such configuration.

The steps of a method or algorithm described in connection with the aspects disclosed herein may be embodied directly in hardware, in a software module executed by a processor (e.g., of a computer), or in a combination of the two. A software module may reside, for example, in RAM memory, flash memory, ROM memory, EPROM memory, EEPROM memory, registers, hard disk, a removable disk, a CD-ROM, or any other form of storage medium. An example storage medium may be coupled to the processor such that the processor may read information from, and write information to, the storage medium. In the alternative, the storage medium may be integral to the processor. The processor and the storage medium may reside in an ASIC.

In at least some aspects, a processing system (e.g., the control module 114 and/or the controller 202) that implements a portion or all of one or more of the technologies described herein may include a general-purpose computer system that includes or is configured to access one or more computer-accessible media.

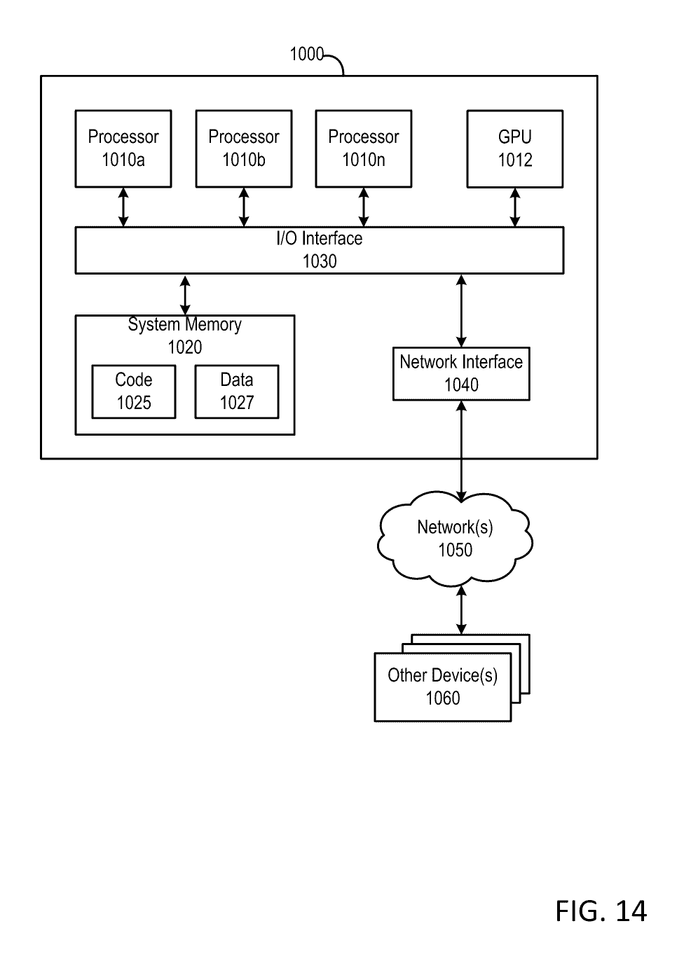

FIG. 14 depicts a general-purpose computer system that includes or is configured to access one or more computer-accessible media. In the illustrated aspect, a computing device 1000 may include one or more processors 1010a, 1010b, and/or 1010n (which may be referred herein singularly as the processor 1010 or in the plural as the processors 1010) coupled to a system memory 1020 via an input/output (I/O) interface 1030. The computing device 1000 may further include a network interface 1040 coupled to an I/O interface 1030.

In various aspects, the computing device 1000 may be a uniprocessor system including one processor 1010 or a multiprocessor system including several processors 1010 (e.g., two, four, eight, or another suitable number). The processors 1010 may be any suitable processors capable of executing instructions. For example, in various aspects, the processor(s) 1010 may be general-purpose or embedded processors implementing any of a variety of instruction set architectures (ISAs), such as the x86, PowerPC, SPARC, or MIPS ISAs, or any other suitable ISA. In multiprocessor systems, each of the processors 1010 may commonly, but not necessarily, implement the same ISA.

In some aspects, a graphics processing unit (“GPU”) 1012 may participate in providing graphics rendering and/or physics processing capabilities. A GPU may, for example, include a highly parallelized processor architecture specialized for graphical computations. In some aspects, the processors 1010 and the GPU 1012 may be implemented as one or more of the same type of device.

The system memory 1020 may be configured to store instructions and data accessible by the processor(s) 1010. In various aspects, the system memory 1020 may be implemented using any suitable memory technology, such as static random access memory (“SRAM”), synchronous dynamic RAM (“SDRAM”), nonvolatile/Flash®-type memory, or any other type of memory. In the illustrated aspect, program instructions and data implementing one or more desired functions, such as those methods, techniques and data described above, are shown stored within the system memory 1020 as code 1025 and data 1027.

In one aspect, the I/O interface 1030 may be configured to coordinate I/O traffic between the processor(s) 1010, the system memory 1020 and any peripherals in the device, including a network interface 1040 or other peripheral interfaces. In some aspects, the I/O interface 1030 may perform any necessary protocol, timing or other data transformations to convert data signals from one component (e.g., the system memory 1020) into a format suitable for use by another component (e.g., the processor 1010). In some aspects, the I/O interface 1030 may include support for devices attached through various types of peripheral buses, such as a variant of the Peripheral Component Interconnect (PCI) bus standard or the Universal Serial Bus (USB) standard, for example. In some aspects, the function of the I/O interface 1030 may be split into two or more separate components, such as a north bridge and a south bridge, for example. Also, in some aspects some or all of the functionality of the I/O interface 1030, such as an interface to the system memory 1020, may be incorporated directly into the processor 1010.

The network interface 1040 may be configured to allow data to be exchanged between the computing device 1000 and other device or devices 1060 attached to a network or networks 1050, such as other computer systems or devices, for example. In various aspects, the network interface 1040 may support communication via any suitable wired or wireless general data networks, such as types of Ethernet networks, for example. Additionally, the network interface 1040 may support communication via telecommunications/telephony networks, such as analog voice networks or digital fiber communications networks, via storage area networks, such as Fibre Channel SANs (storage area networks), or via any other suitable type of network and/or protocol.

In some aspects, the system memory 1020 may be one aspect of a computer-accessible medium configured to store program instructions and data as described above for implementing aspects of the corresponding methods and apparatus. However, in other aspects, program instructions and/or data may be received, sent, or stored upon different types of computer-accessible media. Generally speaking, a computer-accessible medium may include non-transitory storage media or memory media, such as magnetic or optical media, e.g., disk or DVD/CD coupled to computing device the 1000 via the I/O interface 1030. A non-transitory computer-accessible storage medium may also include any volatile or non-volatile media, such as RAM (e.g., SDRAM, DDR SDRAM, RDRAM, SRAM, etc.), ROM, etc., that may be included in some aspects of the computing device 1000 as the system memory 1020 or another type of memory. Further, a computer-accessible medium may include transmission media or signals, such as electrical, electromagnetic or digital signals, conveyed via a communication medium, such as a network and/or a wireless link, such as those that may be implemented via the network interface 1040. Portions or all of multiple computing devices, such as those illustrated in FIG. 14, may be used to implement the described functionality in various aspects; for example, software components running on a variety of different devices and servers may collaborate to provide the functionality. In some aspects, portions of the described functionality may be implemented using storage devices, network devices or special-purpose computer systems, in addition to or instead of being implemented using general-purpose computer systems. The term “computing device,” as used herein, refers to at least all these types of devices and is not limited to these types of devices.

It should also be appreciated that the systems in the figures are merely illustrative and that other implementations might be used. Additionally, it should be appreciated that the functionality disclosed herein might be implemented in software, hardware, or a combination of software and hardware. Other implementations should be apparent to those skilled in the art. It should also be appreciated that a server, gateway, or other computing node may include any combination of hardware or software that may interact and perform the described types of functionality, including without limitation desktop or other computers, database servers, network storage devices and other network devices, PDAs, tablets, cellphones, wireless phones, pagers, electronic organizers, Internet appliances, and various other consumer products that include appropriate communication capabilities. In addition, the functionality provided by the illustrated modules may in some aspects be combined in fewer modules or distributed in additional modules. Similarly, in some aspects the functionality of some of the illustrated modules may not be provided and/or other additional functionality may be available.

Each of the operations, processes, methods, and algorithms described in the preceding sections may be embodied in, and fully or partially automated by, code modules executed by at least one computer or computer processors. The code modules may be stored on any type of non-transitory computer-readable medium or computer storage device, such as hard drives, solid state memory, optical disc, and/or the like. The processes and algorithms may be implemented partially or wholly in application-specific circuitry. The results of the disclosed processes and process steps may be stored, persistently or otherwise, in any type of non-transitory computer storage such as, e.g., volatile or non-volatile storage.

The various features and processes described above may be used independently of one another, or may be combined in various ways. All possible combinations and sub-combinations are intended to fall within the scope of this disclosure. In addition, certain method or process blocks may be omitted in some implementations. The methods and processes described herein are also not limited to any particular sequence, and the blocks or states relating thereto may be performed in other sequences that are appropriate. For example, described blocks or states may be performed in an order other than that specifically disclosed, or multiple blocks or states may be combined in a single block or state. The example blocks or states may be performed in serial, in parallel, or in some other manner. Blocks or states may be added to or removed from the disclosed example aspects. The example systems and components described herein may be configured differently than described. For example, elements may be added to, removed from, or rearranged compared to the disclosed example aspects.

It will also be appreciated that various items are illustrated as being stored in memory or on storage while being used, and that these items or portions of thereof may be transferred between memory and other storage devices for purposes of memory management and data integrity. Alternatively, in other aspects some or all of the software modules and/or systems may execute in memory on another device and communicate with the illustrated computing systems via inter-computer communication. Furthermore, in some aspects, some or all of the systems and/or modules may be implemented or provided in other ways, such as at least partially in firmware and/or hardware, including, but not limited to, at least one application-specific integrated circuits (ASICs), standard integrated circuits, controllers (e.g., by executing appropriate instructions, and including microcontrollers and/or embedded controllers), field-programmable gate arrays (FPGAs), complex programmable logic devices (CPLDs), etc. Some or all of the modules, systems and data structures may also be stored (e.g., as software instructions or structured data) on a computer-readable medium, such as a hard disk, a memory, a network, or a portable media article to be read by an appropriate drive or via an appropriate connection. The systems, modules, and data structures may also be transmitted as generated data signals (e.g., as part of a carrier wave or other analog or digital propagated signal) on a variety of computer-readable transmission media, including wireless-based and wired/cable-based media, and may take a variety of forms (e.g., as part of a single or multiplexed analog signal, or as multiple discrete digital packets or frames). Such computer program products may also take other forms in other aspects. Accordingly, the disclosure may be practiced with other computer system configurations.

Conditional language used herein, such as, among others, “may,” “could,” “might,” “may,” “e.g.,” and the like, unless specifically stated otherwise, or otherwise understood within the context as used, is generally intended to convey that certain aspects include, while other aspects do not include, certain features, elements, and/or steps. Thus, such conditional language is not generally intended to imply that features, elements, and/or steps are in any way required for at least one aspects or that at least one aspects necessarily include logic for deciding, with or without author input or prompting, whether these features, elements, and/or steps are included or are to be performed in any particular aspect. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

While certain example aspects have been described, these aspects have been presented by way of example only, and are not intended to limit the scope of aspects disclosed herein. Thus, nothing in the foregoing description is intended to imply that any particular feature, characteristic, step, module, or block is necessary or indispensable. Indeed, the novel methods and systems described herein may be embodied in a variety of other forms; furthermore, various omissions, substitutions, and changes in the form of the methods and systems described herein may be made without departing from the spirit of aspects disclosed herein. The accompanying claims and their equivalents are intended to cover such forms or modifications as would fall within the scope and spirit of certain aspects disclosed herein.

The preceding detailed description is merely example in nature and is not intended to limit the disclosure or the application and uses of the disclosure. The described aspects are not limited to use in conjunction with a particular type of machine. Hence, although the present disclosure, for convenience of explanation, depicts and describes particular machine, it will be appreciated that the assembly and electronic system in accordance with this disclosure may be implemented in various other configurations and may be used in other types of machines. Furthermore, there is no intention to be bound by any theory presented in the preceding background or detailed description. It is also understood that the illustrations may include exaggerated dimensions to better illustrate the referenced items shown, and are not consider limiting unless expressly stated as such.

It will be appreciated that the foregoing description provides examples of the disclosed system and technique. However, it is contemplated that other implementations of the disclosure may differ in detail from the foregoing examples. All references to the disclosure or examples thereof are intended to reference the particular example being discussed at that point and are not intended to imply any limitation as to the scope of the disclosure more generally. All language of distinction and disparagement with respect to certain features is intended to indicate a lack of preference for those features, but not to exclude such from the scope of the disclosure entirely unless otherwise indicated.

The disclosure may include communication channels that may be any type of wired or wireless electronic communications network, such as, e.g., a wired/wireless local area network (LAN), a wired/wireless personal area network (PAN), a wired/wireless home area network (HAN), a wired/wireless wide area network (WAN), a campus network, a metropolitan network, an enterprise private network, a virtual private network (VPN), an internetwork, a backbone network (BBN), a global area network (GAN), the Internet, an intranet, an extranet, an overlay network, a cellular telephone network, a Personal Communications Service (PCS), using known protocols such as the Global System for Mobile Communications (GSM), CDMA (Code-Division Multiple Access), Long Term Evolution (LTE), W-CDMA (Wideband Code-Division Multiple Access), Wireless Fidelity (Wi-Fi), Bluetooth, and/or the like, and/or a combination of two or more thereof.

Additionally, the various aspects of the disclosure may be implemented in a non-generic computer implementation. Moreover, the various aspects of the disclosure set forth herein improve the functioning of the system as is apparent from the disclosure hereof. Furthermore, the various aspects of the disclosure involve computer hardware that it specifically programmed to solve the complex problem addressed by the disclosure. Accordingly, the various aspects of the disclosure improve the functioning of the system overall in its specific implementation to perform the process set forth by the disclosure and as defined by the claims.

Recitation of ranges of values herein are merely intended to serve as a shorthand method of referring individually to each separate value falling within the range, unless otherwise indicated herein, and each separate value is incorporated into the specification as if it were individually recited herein. All methods described herein may be performed in any suitable order unless otherwise indicated herein or otherwise clearly contradicted by context.

We claim:

1. A system comprising:
a welding apparatus comprising:
a sensor;
a first heat source; and
a second heat source;
a processor; and
a memory bearing instructions that, upon execution by the processor, cause the system at least to:
receive data relating to a weld of a first part to a second part performed by the first heat source, the data comprising at least data from the sensor;
generate, based at least on the data from the sensor, a simulation of the weld;
determine, based at least on the simulation of the weld, a simulated distortion in at least one of the first part and the second part;
determine, based at least on the determined simulated distortion, a heat source application intended to counter a distortion represented by the simulated distortion; and
generate a directive to implement, by the second heat source, the heat source application.

2. The system of claim 1, wherein the instructions further cause the system at least to:
generate a directive to perform a portion of the weld.

3. The system of claim 2, wherein the instructions further cause the system at least to:
receive second data relating to the performance of the weld and the distortion, the second data comprising at least second data from the sensor;
update, based at least on the second data from the sensor, the simulation of the weld;
determine, based at least on the updated simulation of the weld, a second simulated distortion in at least one of the first part and the second part;
determine, based at least on the determined second simulated distortion, a second heat source application intended to counter a second distortion represented by the second simulated distortion; and
generate a second directive to implement, by the second heat source, the second heat source application.

4. The system of claim 3, wherein the second simulated distortion is determined based, at least, on a simulated heat from the second heat source.

5. The system of claim 1, wherein the second heat source is attached to a movable arm.

6. The system of claim 1, wherein:
the welding apparatus further comprises a clamp in which one or more of the first part and the second part are secured; and
the sensor is attached to the clamp.

7. The system of claim 1, wherein the sensor comprises a force sensor.

8. A method comprising:
receiving, by one or more processors, data relating to a weld of a first part to a second part performed by a welding apparatus, the data comprising at least data from a sensor of the welding apparatus;
generating, by one or more processors, based at least on the data from the sensor, a simulation of the weld;
determining, by one or more processors, based at least on the simulation of the weld, a simulated distortion in at least one of the first part and the second part;
determining, by one or more processors, based at least on the determined simulated distortion, a heat source application intended to counter a distortion represented by the simulated distortion; and
generating, by one or more processors, a directive to implement the heat source application.

9. The method of claim 8, further comprising:
generating, by one or more processors, a directive to perform a portion of the weld.

10. The method of claim 9, further comprising:
receiving, by one or more processors, second data relating to the performance of the weld and the distortion, the second data comprising at least second data from the sensor;
updating, by one or more processors, based at least on the second data from the sensor, the simulation of the weld;
determining, by one or more processors, based at least on the updated simulation of the weld, a second simulated distortion in at least one of the first part and the second part;
determining, by one or more processors, based at least on the determined second simulated distortion, a second heat source application intended to counter a second distortion represented by the second simulated distortion; and
generating, by one or more processors, a second directive to implement the second heat source application.

11. The method of claim 10, wherein the second simulated distortion is determined based, at least, on a simulated heat from the implemented heat source application and a simulated heat from the implemented second heat source application.

12. The method of claim 8, wherein the directive to implement the heat source application comprises a position to which a movable arm with an attached heat source is to be positioned.

13. The method of claim 8, wherein the sensor comprises a force sensor.

14. The method of claim 8, wherein:
the welding apparatus further comprises a clamp in which one or more of the first part and the second part are secured; and
the sensor is attached to the clamp.

15. A system comprising:
a welding apparatus comprising:
a sensor;
a first heat source; and
a plurality of fixed heat sources;
a processor; and
a memory bearing instructions that, upon execution by the processor, cause the system at least to:
receive data relating to a weld of a first part to a second part performed by the first heat source, the data comprising at least data from the sensor;
generate, based at least on the data from the sensor, a simulation of the weld;
determine, based at least on the simulation of the weld, a simulated distortion in at least one of the first part and the second part;
determine, based at least on the determined simulated distortion, a heat source application intended to counter a distortion represented by the simulated distortion; and
generate a directive to implement, by an activation of at least one of the plurality of fixed heat sources, the heat source application.

16. The system of claim 15, wherein the instructions further cause the system at least to:
generate a directive to perform a portion of the weld.

17. The system of claim 16, wherein the instructions further cause the system at least to:
receive second data relating to the performance of the weld and the distortion, the second data comprising at least second data from the sensor;
update, based at least on the second data from the sensor, the simulation of the weld;
determine, based at least on the updated simulation of the weld, a second simulated distortion in at least one of the first part and the second part;
determine, based at least on the determined second simulated distortion, a second heat source application intended to counter a second distortion represented by the second simulated distortion; and
generate a second directive to implement, by a second activation of at least one of the plurality of fixed heat sources, the second heat source application.

18. The system of claim 17, wherein the second simulated distortion is caused, at least, by heat from at least one of the fixed heat sources of the plurality of fixed heat sources.

19. The system of claim 15, wherein the first heat source is attached to a movable arm.

20. The system of claim 15, wherein:
the welding apparatus further comprises a clamp in which one or more of the first part and the second part are secured; and
the sensor is attached to the clamp.
